(19) United States
(12) Patent Application Publication
(10) Pub. No.: US 2025/0157753 A1
(43) Pub. Date: May 15, 2025

(54) PUSH BUTTON DEVICE AND VEHICLE

(71) Applicant: TOYO DENSO KABUSHIKI KAISHA, Tokyo (JP)

(72) Inventors: Mitsuhiro KONDO, Tsurugashima-shi (JP); Seiya HAGIMOTO, Tsurugashima-shi (JP)

(21) Appl. No.: 18/904,139

(22) Filed: Oct. 2, 2024

(30) Foreign Application Priority Data
Nov. 13, 2023 (JP) 2023-193188

(51) Int. Cl. H01H 13/14; B60K 35/10

(52) U.S. Cl. CPC H01H 13/14; B60K 35/10

(57) ABSTRACT

A push button device capable of preventing a simultaneous operation of operators having an exclusive relationship and suppressing rising up of the operator that is not operated. During a pressing stroke of a knob 10, a first pressing portion 11 presses a first abutment portion 41, causing a second abutment portion 42 to move in a direction approaching a second pressing portion 21, and during a pressing stroke of a knob 20, the second pressing portion 21 presses the second abutment portion 42, causing the first abutment portion 41 to move in a direction approaching the first pressing portion 11. In a neutral position of a rocking member 40, in the Z direction, a first gap D1 has occurred between the first pressing portion 11 and the first abutment portion 41, and a second gap D2 has occurred between the second pressing portion 21 and the second abutment portion 42. In the pressing stroke of the knob 10 and the knob 20, a movement amount X2 of the second abutment portion 42 is equal to or less than the second gap D2 and a movement amount X1 of the first abutment portion 41 is equal to or less than the first gap D1.

### BACKGROUND OF THE INVENTION

### Field of the Invention

The present invention relates to a push button device and a vehicle.

### Description of the Related Art

A Push button device including two or more operators that should be operated exclusively has been known. For example, in Japanese Laid-Open Patent Publication (kokai) No. 2001-110275, an interlock function is provided to prevent a simultaneous pressing operation of such operators. When an operator is pressed, an interlock piece tilts and then the interlock piece abuts on a portion of an operator located in an opposing position, thereby achieving interlocking.

However, in Japanese Laid-Open Patent Publication (kokai) No. 2001-110275, the operator opposing to the operated operator is pushed up by the interlock piece. This not only results in an undesirable appearance, but can also affect the quality. For example, in the case that a configuration in which a thin film is attached to the surface of the operator has been adopted, the film may bulge every time the operator is operated, which may affect the durability of the film.

### SUMMARY OF THE INVENTION

The present invention provides a push button device capable of preventing a simultaneous operation of operators having an exclusive relationship and suppressing rising up of the operator that is not operated, and a vehicle.

Accordingly, an aspect of the present invention is to provide a push button device comprising a first operator that includes a first pressing portion and is press-operated, a second operator that includes a second pressing portion and is press-operated, a case, and a rocking member that is held to be rockable relative to the case and includes a first abutment portion and a second abutment portion, in which the first pressing portion presses the first abutment portion, causing the second abutment portion to move in a direction approaching the second pressing portion, and the second pressing portion presses the second abutment portion, causing the first abutment portion to move in a direction approaching the first pressing portion, and wherein in a neutral position of the rocking member where both the first operator and the second operator are in a non-operated state, there is a first gap between the first pressing portion and the first abutment portion and there is a second gap between the second pressing portion and the second abutment portion, in a pressing stroke in which the first operator is pressed from the non-operated state to a pressing ending position, a movement amount of the second abutment portion in a direction parallel to a pressing direction of the second operator is equal to or less than the second gap, and in a pressing stroke in which the second operator is pressed from the non-operated state to a pressing ending position, a movement amount of the first abutment portion in a direction parallel to a pressing direction of the first operator is equal to or less than the first gap.

According to the present invention, it is possible to prevent the simultaneous operation of the operators having the exclusive relationship and suppress rising up of the operator that is not operated.

Further features of the present invention will become apparent from the following description of exemplary embodiments with reference to the attached drawings.

### BRIEF DESCRIPTION OF THE DRAWINGS

FIG. 1 is a perspective view of a push button device according to an embodiment of the present invention.

FIG. 2 is an exploded perspective view of the push button device shown in FIG. 1.

FIG. 3A is a perspective view of knobs and a fixing member, and FIG. 3B is a perspective view of a rocking member.

FIG. 4 is a view of the knobs and the fixing member as viewed from the −Z side.

FIG. 5 is a view of the knobs, the rocking member, and the fixing member as viewed from the +X side.

FIG. 6 is an enlarged schematic view of a portion of an elastic engagement portion and a portion of a protrusion, as viewed from the +Y side.

### DESCRIPTION OF THE EMBODIMENTS

Hereinafter, an embodiment of the present invention will be described with reference to the drawings.

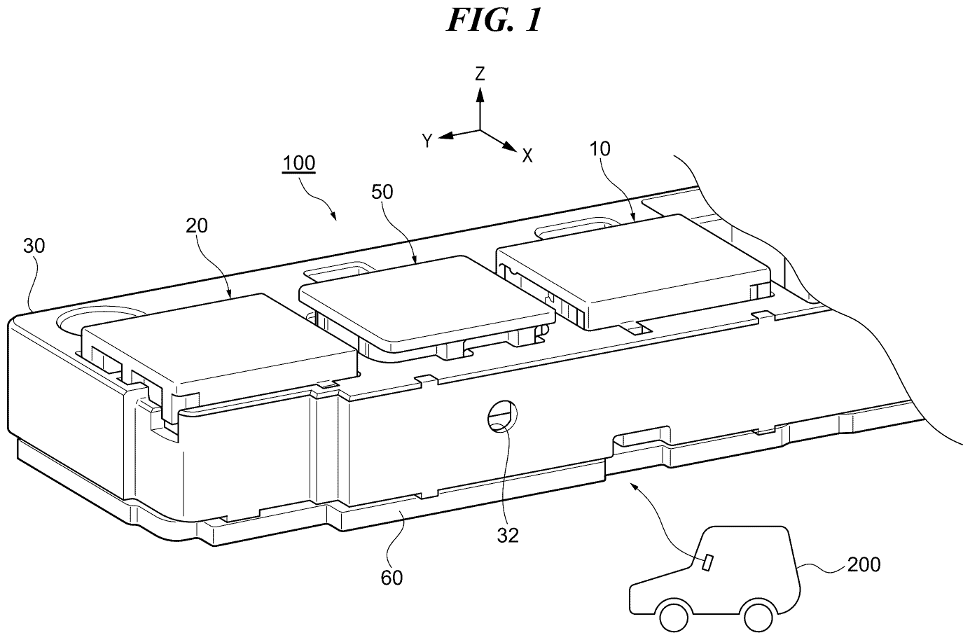

FIG. 1 is a partial perspective view of a push button device 100 according to the embodiment of the present invention. As an example, the push button device 100 is mounted on an operation panel of a vehicle 200. It should be noted that the push button device 100 is not limited to being applicable to a vehicle, and is able to be applied to various types of equipment.

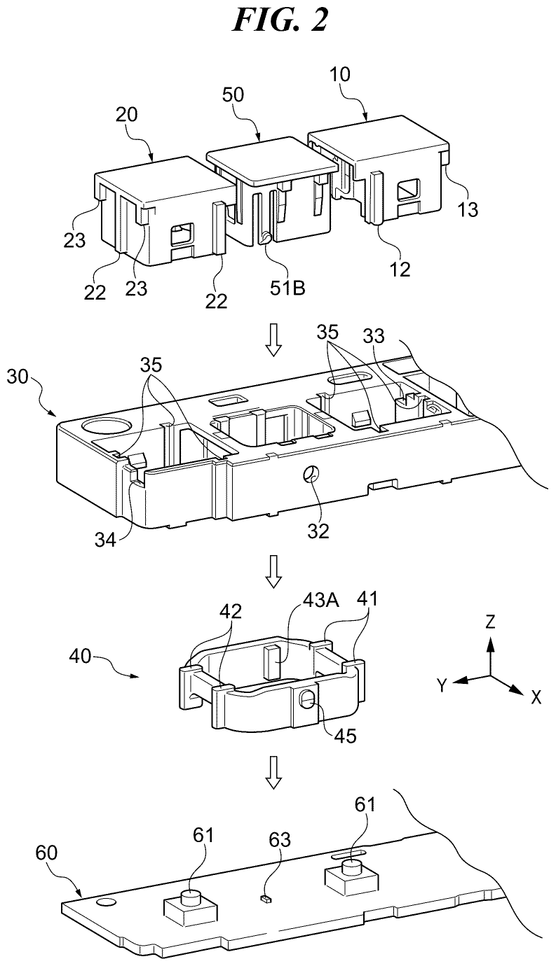

FIG. 2 is an exploded perspective view of the push button device 100. FIG. 1 and FIG. 2 show a portion of the push button device 100, and the remaining portion of the push button device 100 that is not shown in FIG. 1 and FIG. 2 may also have a configuration similar to that shown in FIG. 1 and FIG. The push button device 100 mainly includes a knob 10 (a first operator), a knob 20 (a second operator), a case 30, a rocking member 40, a fixing member 50, and a base plate 60.

Hereinafter, directions of each portion will be referred to on the basis of X, Y, and Z coordinate axes shown in each drawing. A thickness direction and a width direction of the base plate 60 are defined as the Z direction and the X direction, respectively, and a longitudinal direction of the base plate 60 (a direction in which the knob 10, the fixing member 50, and the knob 20 are arranged) is defined as the Y direction. First, the schematic configuration of each portion will be described.

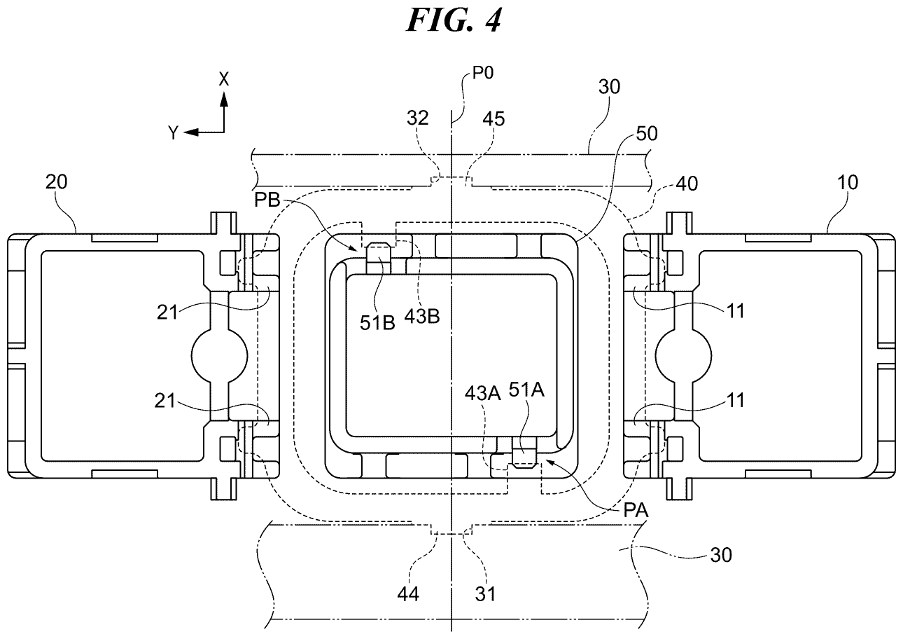

The knob 10 and the knob 20 are operators that are press-operated in the −Z direction. The fixing member 50 is fixed to the case 30. The knob 10 and the knob 20 are assembled to the case 30. The rocking member 40 (see FIG. 2) is held to be rockable relative to the case 30 about a rocking center P0 (see FIG. 4) that is parallel to the X direction. The base plate 60 is fixed to the case 30 with screws (not shown). A plurality of tactile switches 61 (see FIG. 2) are provided on the base plate 60. In addition, an LED 63 is disposed on the base plate 60 in correspondence with the fixing member 50. It should be noted that LEDs corresponding to the knob 10 and the knob 20 may also be provided. It should be noted that the type of the switch disposed on the base plate 60 is not limited to a tactile switch, but may be a rubber contact switch, a metal switch, or the like.

The material of each member does not matter, but as an example, the knob 10, the knob 20, the case 30, the rocking member 40, and the fixing member 50 are made of a resin suitable for the knob 10, a resin suitable for the knob 20, a resin suitable for the case 30, a resin suitable for the rocking member 40, and a resin suitable for the fixing member 50, respectively. In particular, the fixing member 50 is made of a material having elasticity. It should be noted that it is preferable that the materials of the knob 10, the knob 20, and the fixing member 50 have optical transparency.

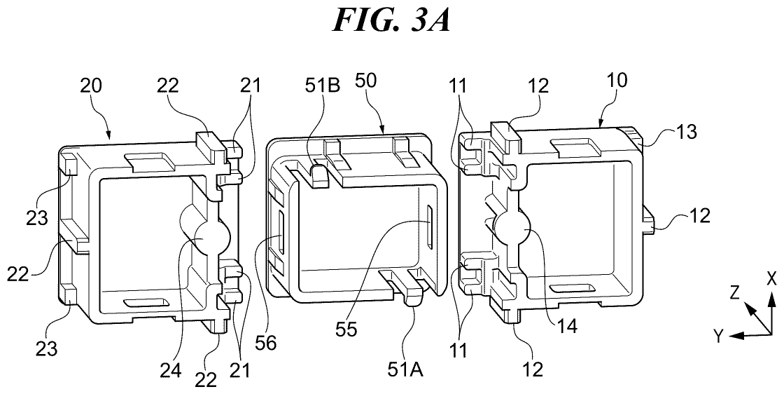

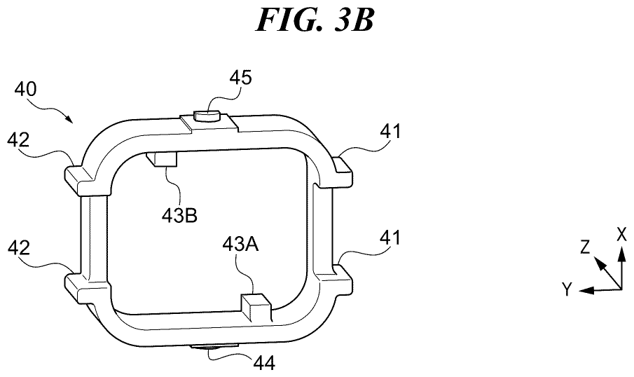

FIG. 3A is a perspective view of the knob 10, the knob 20, and the fixing member 50, and FIG. 3B is a perspective view of the rocking member 40. FIG. 4 is a view of the knob 10, the knob 20, and the fixing member 50 as viewed from the −Z side. The knob 10 and the knob 20 are disposed opposite to each other in the Y direction with the fixing member 50 interposed therebetween. It should be noted that the knob 10 and the knob 20 have the same configuration, but are disposed so that the orientations of the knob 10 and the knob 20 in the Y direction are opposite to each other. It should be noted that the knob 10 and the knob 20 may differ from each other in the material and a partial shape as long as they have the common principal part related to the present invention.

As shown in FIG. 2 and FIG. 3A, the knob 10 is integrally formed and includes a plurality of first pressing portions 11, a plurality of guided portions 12, a plurality of stopper portions 13, and a switch pressing portion 14. In addition, the knob 20 is integrally formed and includes a plurality of second pressing portions 21, a plurality of guided portions 22, a plurality of stopper portions 23, and a switch pressing portion 24. The fixing member 50 is integrally formed and includes an elastic engagement portion 51A (a first elastic engagement portion), an elastic engagement portion 51B (a second elastic engagement portion), and fitting holes 55 and 56.

As shown in FIG. 2 and FIG. 3B, the rocking member 40 is annular and is integrally formed. On the outer peripheral portion of the annular shape of the rocking member 40, in addition to a shaft portion 44 and a shaft portion 45, a plurality of first abutment portions 41 and a plurality of second abutment portions 42 are disposed. The first abutment portion 41 corresponds to the first pressing portion 11 of the knob 10, and the second abutment portion 42 corresponds to the second pressing portion 21 of the knob 20. On the inner peripheral portion of the annular shape of the rocking member 40, a protrusion 43A and a protrusion 43B are disposed. The protrusion 43A and the protrusion 43B correspond to the elastic engagement portion 51A and the elastic engagement portion 51B of the fixing member 50, respectively.

As shown in FIG. 2, the case 30 includes first regulating portions 33 corresponding to the stopper portions 13 and second regulating portions 34 corresponding to the stopper portions 23 (some of which are not shown). In addition, the case 30 includes guide grooves 35 that correspond to the guided portions 12 and the guided portions 22. In addition, as shown in FIG. 4, the case 30 includes a first shaft support portion 31 and a second shaft support portion 32 which are shaft support holes corresponding to the shaft portion 44 and the shaft portion 45. The shaft portion 44 and the shaft portion 45 are shaft-supported by (journaled to) the first shaft support portion 31 and the second shaft support portion 32, and thereby the rocking member 40 is supported at both ends by the first shaft support portion 31 and the second shaft support portion 32 and becomes capable of rocking freely about the rocking center P0.

The fixing member 50 is inserted relatively to the case 30 from the +Z side. The case 30 is formed with protruded portions (not shown) corresponding to the fitting holes 55 and 56 of the fixing member 50, and these protruded portions are fitted into the fitting holes 55 and 56, whereby the fixing member 50 is fixed to the case 30. It should be noted that the method of fixing the fixing member 50 to the case 30 does not matter.

Next, engagement relationships and operations of the respective portions will be described.

The guided portions 12 of the knob 10 and the guided portions 22 of the knob 20 are engaged with the guide grooves 35 of the case 30, whereby the movement of the knob 10 and the knob 20 in the Z direction is guided. When the knob 10 and the knob 20 are press-operated, the corresponding tactile switches 61 are turned on. During a pressing stroke of the knob 10, the stopper portions 13 of the knob 10 abut on the first regulating portions 33 of the case 30, whereby a pressing ending position of the knob 10 in a pressing direction (the −Z direction) is regulated. Similarly, during a pressing stroke of the knob 20, the stopper portions 23 of the knob 20 abut on the second regulating portions 34 of the case 30, whereby a pressing ending position of the knob 20 in the pressing direction is regulated.

When the knob 10 and the knob 20 are released from the pressing, elasticity of the tactile switches 61 provides a returning force to the knob 10 and the knob 20, causing the knob 10 and the knob 20 to return to a non-operated state that is an initial position state. It should be noted that in FIG. 1, the knob 10 and the knob 20 are in the non-operated state. In addition, when the knob 10 and the knob 20 are press-operated, the rocking member 40 rocks. Here, the knob 10 and the knob 20 are operators that should be operated exclusively, and the rocking member 40 is provided to perform an interlock function that avoids (prevents) the simultaneous operation. The knob 10 and the knob 20 may be used, for example, to perform volume control of an audio system or temperature control of an air conditioner.

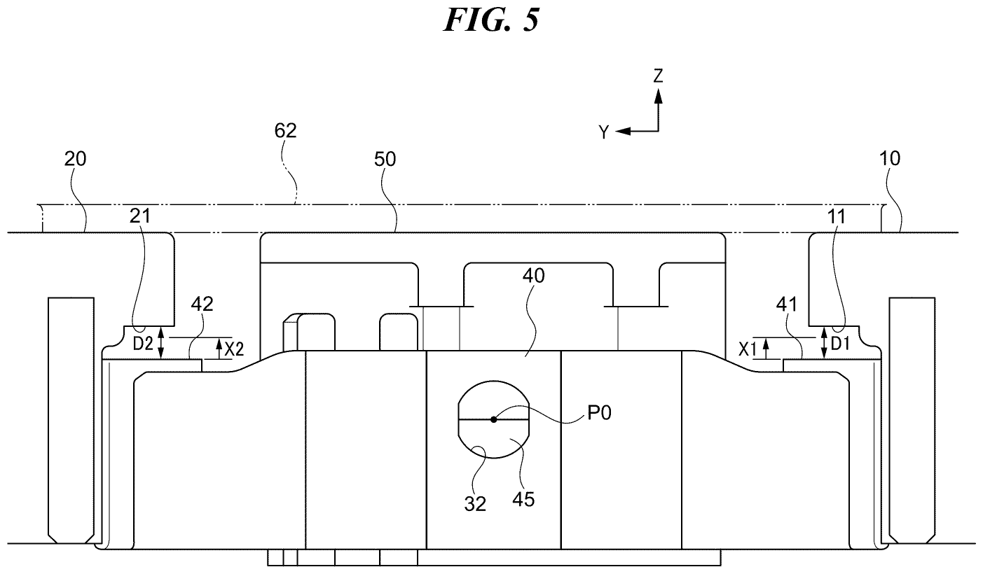

FIG. 5 is a view of the knob 10, the knob 20, the rocking member 40, and the fixing member 50 as viewed from the +X side. Although not shown in FIG. 1, the knob 10, the knob 20, and the fixing member 50 are covered from the +Z side with an elastic film 62 having optical transparency. Therefore, in fact, the knob 10 and the knob 20 are press-operated via the elastic film 62. In FIG. 5, the knob 10 and the knob 20 are in the non-operated state, and the rocking member 40 is in a neutral position with respect to a rocking direction.

When the knob 10 is pressed, the rocking member 40 rocks in the clockwise direction in FIG. 5. In other words, during the pressing stroke of the knob 10, the first pressing portion 11 presses the first abutment portion 41 of the rocking member 40, causing the second abutment portion 42 of the rocking member 40 to move in a direction approaching the second pressing portion 21 (approximately in the +Z direction). On the other hand, when the knob 20 is pressed, the rocking member 40 rocks in the counter-clockwise direction in FIG. 5. In other words, during the pressing stroke of the knob 20, the second pressing portion 21 presses the second abutment portion 42 of the rocking member 40, causing the first abutment portion 41 of the rocking member 40 to move in a direction approaching the first pressing portion 11 (approximately in the +Z direction).

In the neutral position of the rocking member 40, in the Z direction, a first gap D1 has occurred between the first pressing portion 11 and the first abutment portion 41. In addition, a second gap D2 has occurred between the second pressing portion 21 and the second abutment portion 42. As described above, the pressing ending position of the knob 10 is regulated by the first regulating portions 33 and the pressing ending position of the knob 20 is regulated by the second regulating portions 34, so that the pressing stroke is fixed.

In a pressing stroke in which the knob 10 is pressed from the non-operated state to the pressing ending position, a movement amount of the second abutment portion 42 in the Z direction is X2. In addition, in a pressing stroke in which the knob 20 is pressed from the non-operated state to the pressing ending position, a movement amount of the first abutment portion 41 in the Z direction is X1. Here, it has been set so that the movement amount X2 is equal to or less than the second gap D2 and the movement amount X1 is equal to or less than the first gap D1 (X1≤D1 and X2≤D2).

When the knob 10 reaches the pressing ending position, since the second abutment portion 42 comes close to the second pressing portion 21 or slightly abuts on the second pressing portion 21, even if the knob 20 is press-operated, the movement of the knob 20 in the −Z direction is regulated. On the other hand, when the knob 20 reaches the pressing ending position, since the first abutment portion 41 comes close to the first pressing portion 11 or slightly abuts on the first pressing portion 11, even if the knob 10 is press-operated, the movement of the knob 10 in the −Z direction is regulated. As a result, the simultaneous pressing operation of the knob 10 and the knob 20 is avoided.

In addition, since X1≤D1 and X2≤D2 have been set as described above, it is possible to prevent one of the knob 10 and the knob 20 that is not operated from moving toward the +Z side (rising up). This prevents the elastic film 62 from bulging every time the knob is operated, and there is no risk of affecting the durability of the elastic film 62.

The configuration in which the rocking member 40 automatically returns to the neutral position when the pressing of the knob 10 and the knob 20 that have been pressed is released is as follows.

First, the elastic engagement portion 51A and the elastic engagement portion 51B of the fixing member 50 are extension pieces that hang down in the −Z direction, and are easily deflected mainly in the X direction. As shown in FIG. 4, the elastic engagement portion 51A and the protrusion 43A of the rocking member 40 are disposed in a first position PA so as to be engageable with each other. In addition, the elastic engagement portion 51B and the protrusion 43B of the rocking member 40 are disposed in a second position PB so as to be engageable with each other. The first position PA and the second position PB are located on the −Y side and the +Y side of the rocking center P0 when viewed from the Z direction.

The first position PA is located on the side closer to the first shaft support portion 31 than the second shaft support portion 32 (the −X side) in an axial direction of the rocking center P0 (the X direction), and the second position PB is located on the side closer to the second shaft support portion 32 than the first shaft support portion 31 (the +X side) in the above-mentioned axial direction.

When the rocking member 40 is in the neutral position, the elastic engagement portion 51A and the protrusion 43A are engaged with each other, and the elastic engagement portion 51B and the protrusion 43B are engaged with each other. When the knob 10 reaches the pressing ending position, although the elastic engagement portion 51A and the protrusion 43A are engaged with each other, the engagement between the elastic engagement portion 51B and the protrusion 43B is released. Conversely, when the knob 20 reaches the pressing ending position, although the elastic engagement portion 51B and the protrusion 43B are engaged with each other, the engagement between the elastic engagement portion 51A and the protrusion 43A is released.

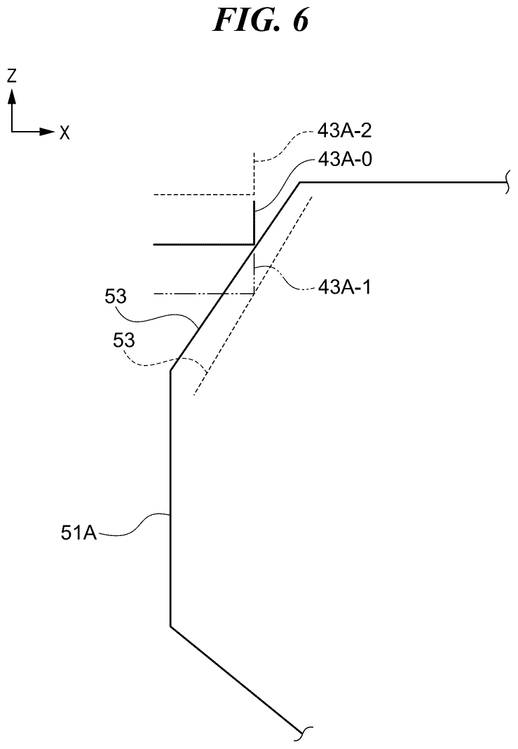

The engagement relationship between the elastic engagement portion 51A and the protrusion 43A when the knob 10 or the knob 20 is pressed is the same as the engagement relationship between the elastic engagement portion 51B and the protrusion 43B. Therefore, by using FIG. 6, the engagement relationship between the elastic engagement portion 51A and the protrusion 43A will be mainly described as a representative example.

FIG. 6 is an enlarged schematic view of a portion of the elastic engagement portion 51A and a portion of the protrusion 43A, as viewed from the +Y side. The elastic engagement portion 51A has an inclined surface 53 formed thereon that faces both the +Z side and the −X side. It should be noted that although not shown, the elastic engagement portion 51B also has an inclined surface 53 formed thereon that faces both the +Z side and the +X side. In FIG. 6, the protrusion 43A in the non-operated state of the knob 10 and the knob 20 is indicated as a protrusion 43A-0. The protrusion 43A corresponding to the pressing ending position of the knob 10 is indicated as a protrusion 43A-1. The protrusion 43A corresponding to the pressing ending position of the knob 20 is indicated as a protrusion 43A-2.

In the non-operated state of the knob 10 and the knob 20 (When the knob 10 and the knob 20 are in the non-operated state), the rocking member 40 is in a neutral position, and the inclined surface 53 of the elastic engagement portion 51A and the protrusion 43A (43A-0) are lightly engaged with each other. The inclined surface 53 of the elastic engagement portion 51B and the protrusion 43B are also lightly engaged with each other. That is, the rocking member 40 is elastically engaged with both the elastic engagement portion 51A and the elastic engagement portion 51B. As a result, the rocking member 40 receives a biasing force in the +Z direction from the inclined surfaces 53 on both sides, so that the posture is stable without any rattling in the neutral position, and the occurrence of mechanical noises and the like is suppressed.

When the knob 10 is pressed, the rocking member 40 rocks, causing the protrusion 43A to move down. When the knob 10 reaches the pressing ending position, the protrusion 43A (43A-1) is tightly engaged with the inclined surface 53 of the elastic engagement portion 51A. At that time, the elastic engagement portion 51A is deflected in the +X direction, generating a stronger biasing force than in the non-operated state. As a result, the rocking member 40 receives a stronger biasing force in the +Z direction from the inclined surface 53 of the elastic engagement portion 51A. Therefore, when the knob 10 is released from the pressed state (when the pressing operation of the knob 10 is released), the rocking member 40 automatically returns to the neutral position.

On the other hand, during the pressing stroke of the knob 20, the protrusion 43A rises, and the engagement between the protrusion 43A and the inclined surface 53 weakens. Then, when the knob 20 reaches the pressing ending position, the protrusion 43A (43A-2) leaves the inclined surface 53 and is no longer engaged with the inclined surface 53. As a result, the rocking member 40 is no longer subjected to the biasing force from the inclined surface 53 of the elastic engagement portion 51A. It should be noted that at this time, the protrusion 43B is tightly engaged with the inclined surface 53 of the elastic engagement portion 51B. Since the protrusion 43A and the inclined surface 53 are not engaged with each other, the protrusion 43A does not hinder the return of the rocking member 40 to the neutral position when the pressing operation of the knob 20 is released.

In this way, when the knob 10 is in the pressing ending position, the elastic engagement portion 51A and the protrusion 43A are engaged with each other, and the elastic engagement portion 51B and the protrusion 43B are not engaged with each other, and when the knob 20 is in the pressing ending position, the elastic engagement portion 51B and the protrusion 43B are engaged with each other, and the elastic engagement portion 51A and the protrusion 43A are not engaged with each other. Therefore, even when the pressing operation of either the knob 10 or the knob 20 is released, the rocking member 40 is able to efficiently obtain a returning force to the neutral position.

It should be noted that when the knob 20 reaches the pressing ending position, it is not essential that the engagement between the protrusion 43A and the elastic engagement portion 51A is completely released. Even in the case that a design has been adopted in which the engagement between the protrusion 43A and the elastic engagement portion 51A continues even when the knob 20 reaches the pressing ending position, since the biasing force toward the +Z side by the protrusion 43A and the elastic engagement portion 51A is weakened, the return of the rocking member 40 to the neutral position is not significantly hindered. The same can be considered for the engagement relationship between the protrusion 43B and the elastic engagement portion 51B when the knob 10 is pressed.

According to the present embodiment, since the gaps and the movement amounts during the pressing strokes of the knob 10 and the knob 20 have been set to X1≤D1 and X2≤D2, it is possible to prevent the simultaneous operation of the operators having an exclusive relationship (the knob 10 and the knob 20) and suppress rising up of the operator that is not operated.

Furthermore, when the pressing operation of the knob 10 or the knob 20 is released, the rocking member 40 returns to the neutral position by the biasing force received from the elastic engagement portion 51A or the elastic engagement portion 51B, so that the operation becomes stable.

In addition, when the rocking member 40 is in the neutral position, the rocking member 40 is engaged with both the elastic engagement portion 51A and the elastic engagement portion 51B, and the elastic engagement portion 51A and the elastic engagement portion 51B are disposed on both sides of the rocking center P0, so that it is possible to effectively suppress rattling of the rocking member 40 in the neutral position. Moreover, the elastic engagement portion 51A and the elastic engagement portion 51B are respectively disposed on the −X side portion and the +X side portion of the rocking member 40 in the axial direction of the rocking center P0, so that the balance is stable and the rattle suppression effect is high.

In addition, when the knob 10 or the knob 20 is in the pressing ending position, either the pair of the elastic engagement portion 51A and the protrusion 43A or the pair of the elastic engagement portion 51B and the protrusion 43B is not in the engaged state. Therefore, even when the pressing operation of either the knob 10 or the knob 20 is released, the rocking member 40 is able to efficiently return to the neutral position.

In addition, since the fixing member 50 is made of an elastic material (the fixing member 50 is configured with an elastic member) and the elastic engagement portion 51A and the elastic engagement portion 51B are part of the fixing member 50, the rocking member 40 obtains the biasing force from the fixing member 50, which is a common member, in the case of returning to the neutral position from any inclined posture. Therefore, the configuration is prevented from becoming complicated.

It should be noted that the fixing member 50 may be formed integrally with the case 30. In this case, the case 30 may be made of an elastic material (the case 30 may be configured with an elastic member), and the elastic engagement portion 51A and the elastic engagement portion 51B may be configured as part of the case 30.

It should be noted that the push button device 100 may include a plurality of sets having the same configuration as the set consisting of the knob 10, the knob 20, the elastic engagement portion 51A, the elastic engagement portion 51B, and the rocking member 40.

It should be noted that the configuration of the elastic engagement portion 51A and the elastic engagement portion 51B is not limited to the example shown, and may be any configuration that biases the rocking member 40 toward the neutral position.

It should be noted that a portion that regulates the pressing ending position of the knob 10 (a portion corresponding to the first regulating portions 33) may be provided at any location, and may be provided on a member other than the case 30 (for example, the base plate 60). In addition, a portion that regulates the pressing ending position of the knob 20 (a portion corresponding to the second regulating portions 34) may be provided at any location, and may be provided on a member other than the case 30 (for example, the base plate 60).

The present invention has been described in detail above based on its preferred embodiments, but the present invention is not limited to these specific embodiments, and various forms that do not deviate from the gist of the present invention are also included in the present invention.

This application claims the benefit of Japanese Patent Application No. 2023-193188, filed on Nov. 13, 2023, which is hereby incorporated by reference herein in its entirety.

What is claimed is:

1. A push button device comprising:
a first operator that includes a first pressing portion and is press-operated;
a second operator that includes a second pressing portion and is press-operated;
a case; and
a rocking member that is held to be rockable relative to the case and includes a first abutment portion and a second abutment portion, in which the first pressing portion presses the first abutment portion, causing the second abutment portion to move in a direction approaching the second pressing portion, and the second pressing portion presses the second abutment portion, causing the first abutment portion to move in a direction approaching the first pressing portion, and
wherein in a neutral position of the rocking member where both the first operator and the second operator are in a non-operated state, there is a first gap between the first pressing portion and the first abutment portion and there is a second gap between the second pressing portion and the second abutment portion,
in a pressing stroke in which the first operator is pressed from the non-operated state to a pressing ending position, a movement amount of the second abutment portion in a direction parallel to a pressing direction of the second operator is equal to or less than the second gap, and
in a pressing stroke in which the second operator is pressed from the non-operated state to a pressing ending position, a movement amount of the first abutment portion in a direction parallel to a pressing direction of the first operator is equal to or less than the first gap.

2. The push button device according to claim 1, wherein
the case or a member fixed to the case is provided with an elastic engagement portion that is engaged with the rocking member, and
when a pressing operation is released in a state in which the first operator or the second operator is in the pressing ending position, the rocking member is returned to the neutral position by a biasing force received from the elastic engagement portion.

3. The push button device according to claim 2, wherein
the elastic engagement portion is provided at a first position and a second position across a rocking center of the rocking member when viewed from the pressing direction of the first operator or the second operator, and
when the rocking member is in the neutral position, the rocking member is engaged with both the elastic engagement portion provided at the first position and the elastic engagement portion provided at the second position.

4. The push button device according to claim 3, wherein
the rocking member is supported at both ends by a first shaft support portion and a second shaft support portion of the case,
the first position is located on a side closer to the first shaft support portion than the second shaft support portion in an axial direction of the rocking center, and
the second position is located on a side closer to the second shaft support portion than the first shaft support portion in the axial direction.

5. The push button device according to claim 3, wherein
the elastic engagement portion includes a first elastic engagement portion provided at the first position and a second elastic engagement portion provided at the second position,
when the first operator is in the pressing ending position, the first elastic engagement portion and the rocking member are engaged with each other, and the second elastic engagement portion and the rocking member are not engaged with each other, and
when the second operator is in the pressing ending position, the second elastic engagement portion and the rocking member are engaged with each other, and the first elastic engagement portion and the rocking member are not engaged with each other.

6. The push button device according to claim 2, wherein
the rocking member is biased toward the neutral position by an engagement between an inclined surface formed on the elastic engagement portion and the rocking member.

7. The push button device according to claim 2, wherein
the member fixed to the case is configured with an elastic member, and the elastic engagement portion is a part of the member.

8. The push button device according to claim 1, further comprising:
a first regulating portion that regulates the pressing ending position of the first operator in the pressing direction of the first operator; and
a second regulating portion that regulates the pressing ending position of the second operator in the pressing direction of the second operator.

9. A vehicle comprising:
a push button device, and
wherein the push button device comprises:
a first operator that includes a first pressing portion and is press-operated;
a second operator that includes a second pressing portion and is press-operated;
a case; and
a rocking member that is held to be rockable relative to the case and includes a first abutment portion and a second abutment portion, in which the first pressing portion presses the first abutment portion, causing the second abutment portion to move in a direction approaching the second pressing portion, and the second pressing portion presses the second abutment portion, causing the first abutment portion to move in a direction approaching the first pressing portion, and
wherein in a neutral position of the rocking member where both the first operator and the second operator are in a non-operated state, there is a first gap between the first pressing portion and the first abutment portion and there is a second gap between the second pressing portion and the second abutment portion,
in a pressing stroke in which the first operator is pressed from the non-operated state to a pressing ending position, a movement amount of the second abutment portion in a direction parallel to a pressing direction of the second operator is equal to or less than the second gap, and
in a pressing stroke in which the second operator is pressed from the non-operated state to a pressing ending position, a movement amount of the first abutment portion in a direction parallel to a pressing direction of the first operator is equal to or less than the first gap.

10. The vehicle according to claim 9, wherein
the case or a member fixed to the case is provided with an elastic engagement portion that is engaged with the rocking member, and
when a pressing operation is released in a state in which the first operator or the second operator is in the pressing ending position, the rocking member is returned to the neutral position by a biasing force received from the elastic engagement portion.

11. The vehicle according to claim 10, wherein
the elastic engagement portion is provided at a first position and a second position across a rocking center of the rocking member when viewed from the pressing direction of the first operator or the second operator, and
when the rocking member is in the neutral position, the rocking member is engaged with both the elastic engagement portion provided at the first position and the elastic engagement portion provided at the second position.

12. The vehicle according to claim 11, wherein
the rocking member is supported at both ends by a first shaft support portion and a second shaft support portion of the case,
the first position is located on a side closer to the first shaft support portion than the second shaft support portion in an axial direction of the rocking center, and
the second position is located on a side closer to the second shaft support portion than the first shaft support portion in the axial direction.

13. The vehicle according to claim 11, wherein
the elastic engagement portion includes a first elastic engagement portion provided at the first position and a second elastic engagement portion provided at the second position,
when the first operator is in the pressing ending position, the first elastic engagement portion and the rocking member are engaged with each other, and the second elastic engagement portion and the rocking member are not engaged with each other, and
when the second operator is in the pressing ending position, the second elastic engagement portion and the rocking member are engaged with each other, and the first elastic engagement portion and the rocking member are not engaged with each other.

14. The vehicle according to claim 10, wherein
the rocking member is biased toward the neutral position by an engagement between an inclined surface formed on the elastic engagement portion and the rocking member.

15. The vehicle according to claim 10, wherein
the member fixed to the case is configured with an elastic member, and the elastic engagement portion is a part of the member.

16. The vehicle according to claim 9, wherein
the push button device further comprises:
a first regulating portion that regulates the pressing ending position of the first operator in the pressing direction of the first operator; and
a second regulating portion that regulates the pressing ending position of the second operator in the pressing direction of the second operator.
